(19) United States
(12) Patent Application Publication
(10) Pub. No.: US 2013/0086571 A1
(43) Pub. Date: Apr. 4, 2013

(54) Dynamically Updating Firmware In A Computing System

(71) Applicants: Shiva R. Dasari, Austin, TX (US); Raghuswamyreddy Gundam, Austin, TX (US); Newton P. Liu, Austin, TX (US); Douglas W. Oliver, Round Rock, TX (US); Terence Rodrigues, Austin, TX (US); Mehul M. Shah, Austin, TX (US); Robert K. Sloan, Pflugerville, TX (US); Wingcheung Tam, Austin, TX (US)

(72) Inventors: Shiva R. Dasari, Austin, TX (US); Raghuswamyreddy Gundam, Austin, TX (US); Newton P. Liu, Austin, TX (US); Douglas W. Oliver, Round Rock, TX (US); Terence Rodrigues, Austin, TX (US); Mehul M. Shah, Austin, TX (US); Robert K. Sloan, Pflugerville, TX (US); Wingcheung Tam, Austin, TX (US)

(73) Assignee: INTERNATIONAL BUSINESS MACHINES CORPORATION, Armonk, NY (US)

(21) Appl. No.: 13/249,437

(22) Filed: Sep. 30, 2011

(51) Int. Cl. G06F 9/44

(52) U.S. Cl. 717/168

(57) ABSTRACT

Dynamically updating firmware in a computing system, including: receiving, by a firmware update module, a request to update firmware in the computing system; receiving, by the firmware update module, a firmware update; storing, by the firmware update module, the firmware update into computer memory of the computing system; and initiating, by the firmware update module, a system management interrupt with the address in computer memory of the computing system at which the firmware update is stored.

### BACKGROUND OF THE INVENTION

1. Field of the Invention

The field of the invention is data processing, or, more specifically, methods, apparatus, and products for dynamically updating firmware in a computing system.

2. Description of Related Art

Modern computing systems often include a plurality of devices and firmware to manage such devices. In order to update firmware, computer memory that includes the firmware must be overwritten with an update to the firmware. After the computer memory that included the original firmware has been overwritten, however, the computing system must be rebooted in order for the firmware update to be completed. Rebooting a computing system can cause a degradation in system performance as various components of the system are unavailable during the reboot process.

### SUMMARY OF THE INVENTION

Dynamically updating firmware in a computing system, including: receiving, by a firmware update module, a request to update firmware in the computing system; receiving, by the firmware update module, a firmware update; storing, by the firmware update module, the firmware update into computer memory of the computing system; and initiating, by the firmware update module, a system management interrupt with the address in computer memory of the computing system at which the firmware update is stored.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an example computing system in which firmware is dynamically updated according to embodiments of the present invention.

FIG. 2 sets forth a flow chart illustrating an exemplary method for dynamically updating firmware in a computing system according to embodiments of the present invention.

FIG. 3 sets forth a flow chart illustrating an exemplary method for dynamically updating firmware in a computing system according to embodiments of the present invention.

### DETAILED DESCRIPTION OF EXEMPLARY EMBODIMENTS

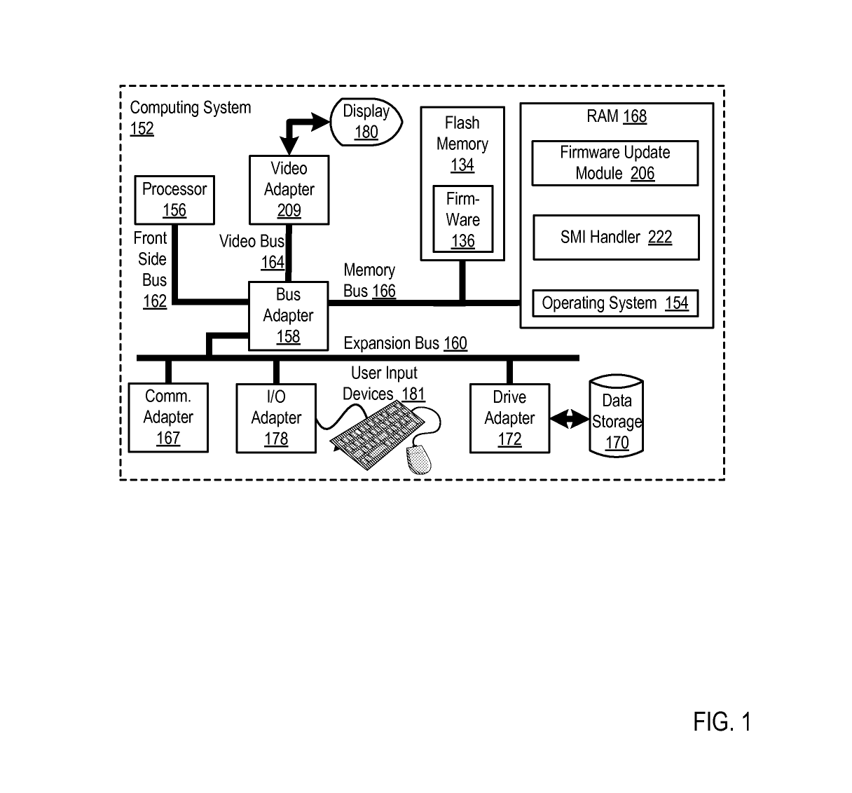

Exemplary methods, apparatus, and products for dynamically updating firmware in a computing system in accordance with the present invention are described with reference to the accompanying drawings, beginning with FIG. 1. FIG. 1 sets forth a block diagram of automated computing machinery comprising an example computing system (152) in which firmware is dynamically updated according to embodiments of the present invention. The computing system (152) of FIG. 1 includes at least one computer processor (156) or ‘CPU’ as well as random access memory (168) (‘RAM’) which is connected through a high speed memory bus (166) and bus adapter (158) to processor (156) and to other components of the computing system (152).

Stored in RAM (168) is a firmware update module (206), a module of computer program instructions improved for dynamically updating firmware (136) in a computing system according to embodiments of the present invention. In the example of FIG. 1, the firmware update module (206) is a module of computer program instructions that, when executed, manages firmware (136) updates within the computing system (152). The firmware update module (206) may present a user interface to a system administrator or other user that enables the system administrator or other user to initiate an update of firmware in the computing system (152), load updated firmware into the computing system (152), disable out-of-date firmware that is loaded into the computing system (152), and so on.

Also stored in RAM (168) is an SMI handler (222), a module of computer program instructions for handling system management interrupts, explained below in detail. In the example of FIG. 1, the SMI handler (222) may be configured to store firmware updates in the computing system (152) and alter the state of various devices in the computing system (152) such that the devices utilize the firmware updates.

In the example of FIG. 1, the firmware update module (206) and the SMI handler (222) are configured to dynamically update firmware (136) in the computing system (152) in accordance with embodiments of the present invention. Dynamically updating firmware (136) in the computing system (152) includes receiving, by the firmware update module (206), a request to update firmware in the computing system. In the example of FIG. 1, receiving a request to update firmware (136) in the computing system (152) may be carried out by receiving a request to update firmware (136) in the computing system (152) through a user interface presented by the firmware update module (206).

Dynamically updating firmware (136) in the computing system (152) may also include receiving, by the firmware update module (206), a firmware update. In the example of FIG. 1, the firmware update may be embodied as a module of computer program instructions that may be stored in memory, including memory of a device within the computing system (152), to serve as firmware within the computing system (152). The firmware update of FIG. 1 may include computer program instructions that were received via a user interface of the firmware update module (206), computer program instructions that were included in the request to update firmware (136), computer program instructions stored in a memory location pointed to by an address contained in the request (202) to update firmware, and so on.

Dynamically updating firmware (136) in the computing system (152) may also include initiating, by the firmware update module (206), a system management interrupt with the address in computer memory of the computing system at which the firmware update is stored. In the example of FIG. 1, a system management interrupt is a signal indicating the need for attention by a system manager. The system management interrupt may be initiated, for example, via a designated SMI# pin of the processor chip, via a software-initiated SMI interrupt instruction, and so on. In response to the system management interrupt, the computing system (152) may enter system management mode (‘SMM’) in which all normal execution, including the execution of the operating system, is suspended and special separate software such as firmware, a hardware-assisted debugger, or an interrupt handler is executed in high-privilege mode.

Dynamically updating firmware (136) in the computing system (152) may also include storing, by a system management interrupt handler (222), the firmware update at a predetermined address in computer memory of the computing system. In the example of FIG. 1, the firmware update may be stored in RAM (168) of the computing system (152), in a disk drive (170) of the computing system (152), in flash memory (134) of the computing system (152), and so on. The computer memory that the firmware update is stored within may be dedicated memory that is only available to the system management interrupt handler (222). The firmware update may alternatively be stored in memory contained on a device in the computing system (152) that the firmware update is designed to control. For example, if the firmware update (204) represents updated firmware for a communications adapter (167) of the computing system (152), the firmware update may be stored on memory that is part of the communications adapter (167) itself.

Dynamically updating firmware (136) in the computing system (152) may also include changing, by the system management interrupt handler (222), a firmware address in the computing system (152) to point to the predetermined address in computer memory of the computing system (152) at which the firmware update is stored. Consider an example in which a firmware update was designed to replace a system management service. In such an example, changing a firmware address of the computing system to point to the predetermined address in computer memory of the computing system (152) at which the firmware update is stored can be carried out, for example, by initiating an additional system management interrupt and changing the SMM base address in each central processing unit (156) to point to the predetermined address in computer memory of the computing system (152) at which the firmware update is stored. Alternatively, consider an example in which a firmware update was designed to replace a Unified Extensible Firmware Interface (‘UEFI’) service. In such an example, changing a firmware address of the computing system to point to the predetermined address in computer memory of the computing system (152) at which the firmware update is stored can be carried out, for example, by updating a function pointer that points to the UEFI service to point to the predetermined address in computer memory of the computing system (152) at which the firmware update is stored.

Also stored in RAM (168) is an operating system (154). Operating systems useful dynamically updating firmware in a computing system according to embodiments of the present invention include UNIX™, Linux™, Microsoft XP™, AIX™, IBM's i5/OS™, and others as will occur to those of skill in the art. The operating system (154), firmware update module (206), and SMI handler (222) in the example of FIG. 1 are shown in RAM (168), but many components of such software typically are stored in non-volatile memory also such as a disk drive (170), flash memory (134), and so on.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of disk drive (170). Disk drive adapters useful in computers for dynamically updating firmware in a computing system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for dynamically updating firmware in a computing system according to embodiments of the present invention include modems for wired dial-up communications, Ethernet (IEEE 802.3) adapters for wired data communications network communications, and 802.11 adapters for wireless data communications network communications.

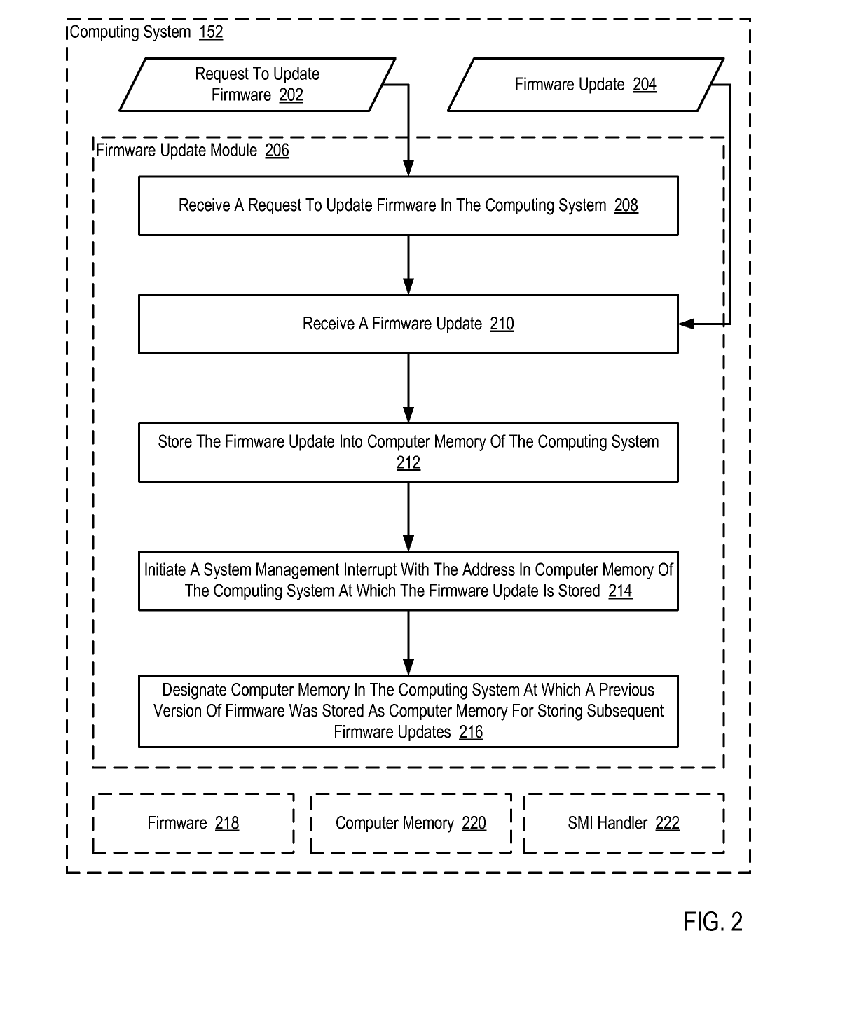

For further explanation, FIG. 2 sets forth a flow chart illustrating an exemplary method for dynamically updating firmware (218) in a computing system (152) according to embodiments of the present invention. In the example of FIG. 2, firmware (218) represents computer program instructions and data structures that are used to control the operation of devices within the computing system (152). Examples of such devices include computer processors, computer memory devices, graphics cards, sound cards, network adapters, expansion cards, and so on. Firmware may generally be classified as boot-time firmware that is run at boot-time to set up the computing system (152) and run-time firmware that may be executed after the operating system of the computing system (152) has been initialized. In the example of FIG. 2, firmware (218) is run-time firmware. The firmware (218) of FIG. 2 may stored in computer memory (220) such as flash memory, a disk drive, or RAM, as well as within memory that resides on the individual devices themselves.

The example method of FIG. 2 includes receiving (208), by a firmware update module (206), a request (202) to update firmware (218) in the computing system (152). In the example method of FIG. 2, the firmware update module (206) is a module of computer program instructions that, when executed, manages firmware updates within the computing system (152). The firmware update module (206) may present a user interface to a system administrator or other user that enables the system administrator or other user to initiate an update of firmware in the computing system (152), load updated firmware into the computing system (152), disable out-of-date firmware that is loaded into the computing system (152), and so on. In the example method of FIG. 2, receiving (208) a request (202) to update firmware (218) in the computing system (152) may therefore be carried out by receiving a request (202) to update firmware (218) in the computing system (152) through a user interface presented by the firmware update module (206).

The example method of FIG. 2 also includes receiving (210), by the firmware update module (206), a firmware update (204). In the example of FIG. 2, the firmware update (204) may be embodied as a module of computer program instructions that may be stored in memory, including memory of a device within the computing system (152), to serve as firmware within the computing system (152). The firmware update (204) of FIG. 2 may include computer program instructions that were received via a user interface of the firmware update module (206), computer program instructions that were included in the request (202) to update firmware (218), computer program instructions stored in a memory location pointed to by an address contained in the request (202) to update firmware (218), and so on. In the example of FIG. 2, the firmware update (204) may include updates to multiple pieces of firmware. For example, the firmware update (204) may include at least one UEFI run-time service and at least one system management service that is executed when the computing system (152) is in enters system management mode.

The example method of FIG. 2 also includes storing (212), by the firmware update module (206), the firmware update (204) into computer memory (220) of the computing system (152). In the example method of FIG. 2, the firmware update (204) may be stored in RAM of the computing system (152), in a disk drive of the computing system (152), and so on. The firmware update (204) may also be stored in memory contained on a device in the computing system (152) that the firmware update (204) is designed to control. For example, if the firmware update (204) represents updated firmware for a network adapter of the computing system (152), the firmware update (204) may be stored on memory that is part of the network adapter itself.

The example method of FIG. 2 also includes initiating (214), by the firmware update module (206), a system management interrupt with the address in computer memory (220) of the computing system (152) at which the firmware update (204) is stored. In the example method of FIG. 2, a system management interrupt is a signal indicating the need for attention by a system manager. The system management interrupt may be initiated (214), for example, via a designated SMI# pin of the processor chip, via a software-initiated SMI interrupt instruction, and so on. In response to the system management interrupt, the computing system (152) may enter system management mode (‘SMM’) in which all normal execution, including the execution of the operating system, is suspended and special separate software such as firmware, a hardware-assisted debugger, or an interrupt handler is executed in high-privilege mode.

In the example method of FIG. 2, the system management interrupt includes the address in computer memory (220) of the computing system (152) at which the firmware update (204) is stored. In the example method of FIG. 2, the address in computer memory (220) of the computing system (152) at which the firmware update (204) is stored may be used by an interrupt handler as the new address for a particular piece of firmware. Consider an example in which firmware resides in memory of a network adapter of the computing system (152) to control the operation of the network adapter. In such an example, the firmware update (204) may also be stored in memory of the network adapter, such that an interrupt handler can reconfigure the network adapter to utilize the firmware update (204) stored at the location in memory specified by the system management interrupt, thereby effectively updating the firmware on the network adapter.

The example method of FIG. 2 also includes designating (216), by the firmware update module (206), computer memory (220) in the computing system (152) at which a previous version of firmware was stored as computer memory for storing subsequent firmware updates. In the example method of FIG. 2, because the computing system (152) may utilize the firmware update (204) in the place of an older version of firmware, the previous version of firmware that the firmware update (204) is designed to replace will no longer be utilized. As such, the computer memory (220) at which the previous version of firmware was stored may be freed and allocated for other uses. In particular, the computer memory (220) in the computing system (152) at which a previous version of firmware was stored may be designated (216) as computer memory for storing subsequent firmware updates.

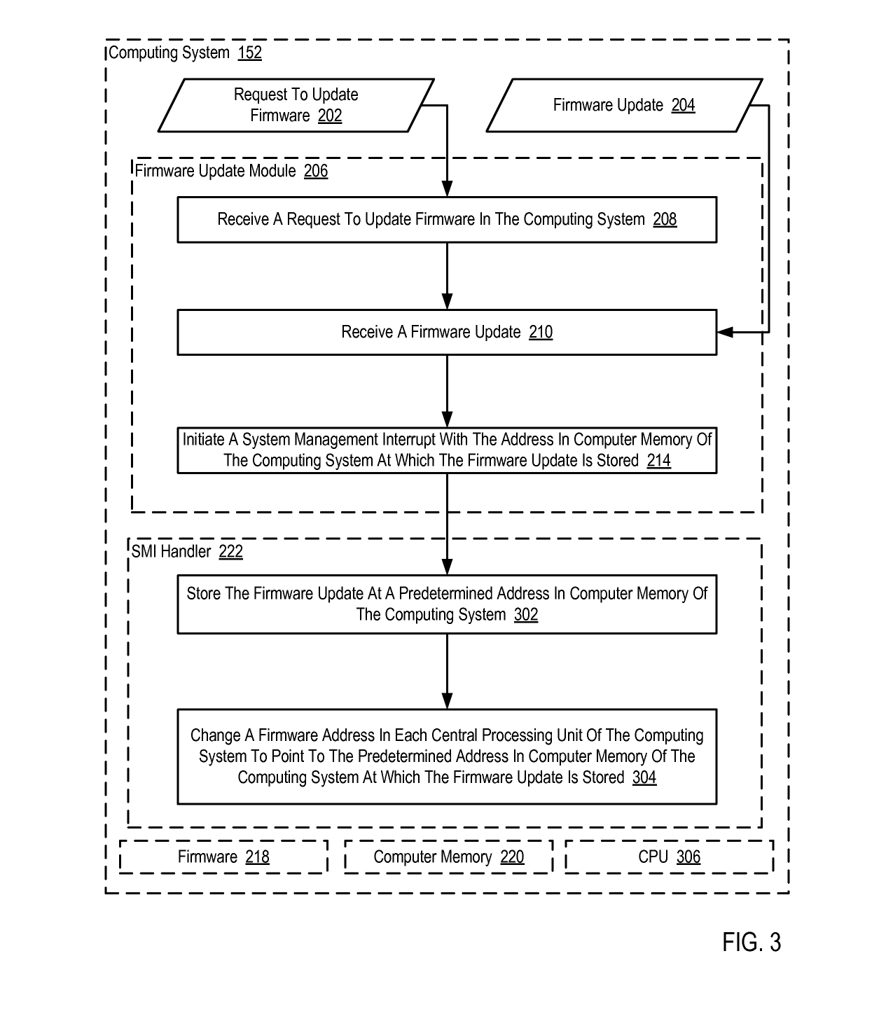

For further explanation, FIG. 3 sets forth a flow chart illustrating a further exemplary method for dynamically updating firmware (218) in a computing system (152) according to embodiments of the present invention. The example method of FIG. 3 is similar to the example method of FIG. 2 as it also includes receiving (208) a request (202) to update firmware (218) in the computing system (152), receiving (210) a firmware update (204), and initiating (214) a system management interrupt with the address in computer memory (220) of the computing system (152) at which the firmware update (204) is stored.

The example method of FIG. 3 also includes storing (302), by a system management interrupt handler (222), the firmware update (204) at a predetermined address in computer memory (220) of the computing system (152). In the example method of FIG. 3, the firmware update (204) may be stored in RAM of the computing system (152), in a disk drive of the computing system (152), in flash memory of the computing system (152), and so on. In the example method of FIG. 3, the computer memory (220) that the firmware update (204) is stored (302) within may be dedicated memory that is only available to the system management interrupt handler (222). The firmware update (204) may alternatively be stored in memory contained on a device in the computing system (152) that the firmware update (204) is designed to control. For example, if the firmware update (204) represents updated firmware for a network adapter of the computing system (152), the firmware update (204) may be stored on memory that is part of the network adapter itself.

In the example method of FIG. 3, the firmware update (204) can include updated run-time service code. As described above, firmware may generally be classified as boot-time firmware that is run at boot-time to set up the computing system (152) and run-time firmware that may be executed after the operating system of the computing system (152) has been initialized. In the example method of FIG. 3, run-time service code, as the term is used here, represents computer program instructions that are to replace some portion of run-time firmware.

The example method of FIG. 3 also includes changing (304), by the system management interrupt handler (222), a firmware address of the computing system to point to the predetermined address in computer memory (220) of the computing system (152) at which the firmware update (204) is stored. Consider an example in which a firmware update (204) was designed to replace a system management service. In such an example, changing (304) a firmware address of the computing system to point to the predetermined address in computer memory (220) of the computing system (152) at which the firmware update (204) is stored can be carried out, for example, by initiating an additional system management interrupt and changing the SMM base address in each central processing unit (306) to point to the predetermined address in computer memory (220) of the computing system (152) at which the firmware update (204) is stored. Alternatively, consider an example in which a firmware update (204) was designed to replace a UEFI service. In such an example, changing (304) a firmware address of the computing system to point to the predetermined address in computer memory (220) of the computing system (152) at which the firmware update (204) is stored can be carried out, for example, by updating a function pointer that points to UEFI service to point to the predetermined address in computer memory (220) of the computing system (152) at which the firmware update (204) is stored. Readers will appreciate that because a firmware address of the computing system was changed (304) to point to the updated firmware, firmware (218) may therefore be updated without rebooting the computing system (152).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of dynamically updating firmware in a computing system, the method comprising:
receiving, by a firmware update module, a request to update firmware in the computing system;
receiving, by the firmware update module, a firmware update; and
initiating, by the firmware update module, a system management interrupt with the address in computer memory of the computing system at which the firmware update is stored.

2. The method of claim 1 further comprising:
storing, by a system management interrupt handler, the firmware update at a predetermined address in computer memory of the computing system; and
changing, by the system management interrupt handler, a firmware address in the computing system to point to the predetermined address in computer memory of the computing system at which the firmware update is stored.

3. The method of claim 1 wherein the request to update firmware in the computing system includes the firmware update.

4. The method of claim 1 wherein the firmware update includes updated run-time service code.

5. The method of claim 1 further comprising designating, by the firmware update module, computer memory in the computing system at which a previous version of firmware was stored as computer memory for storing subsequent firmware updates.

6. The method of claim 1 wherein the firmware update includes at least one Unified Extensible Firmware Interface (‘UEFI’) run-time service and at least one system management service.

7. Apparatus for dynamically updating firmware in a computing system, the apparatus comprising a computer processor, a computer memory operatively coupled to the computer processor, the computer memory having disposed within it computer program instructions that, when executed by the computer processor, cause the apparatus to carry out the steps of:
receiving, by a firmware update module, a request to update firmware in the computing system;
receiving, by the firmware update module, a firmware update;
storing, by the firmware update module, the firmware update into computer memory of the computing system; and
initiating, by the firmware update module, a system management interrupt with the address in computer memory of the computing system at which the firmware update is stored.

8. The apparatus of claim 7 wherein the computer memory also includes computer program instructions that, when executed by the computer processor, cause the apparatus to carry out the steps of:
storing, by a system management interrupt handler, the firmware update at a predetermined address in computer memory of the computing system; and
changing, by the system management interrupt handler, a firmware address in the computing system to point to the predetermined address in computer memory of the computing system at which the firmware update is stored.

9. The apparatus of claim 7 wherein the request to update firmware in the computing system includes the firmware update.

10. The apparatus of claim 7 wherein the firmware update includes updated run-time service code.

11. The apparatus of claim 7 wherein the computer memory also includes computer program instructions that, when executed by the computer processor, cause the apparatus to carry out the step of designating, by the firmware update module, computer memory in the computing system at which a previous version of firmware was stored as computer memory for storing subsequent firmware updates.

12. The apparatus of claim 7 wherein the firmware update includes at least one Unified Extensible Firmware Interface (‘UEFI’) run-time service and at least one system management service.

13. A computer program product for dynamically updating firmware in a computing system, the computer program product disposed upon a computer readable storage medium, the computer program product comprising computer program instructions that, when executed, cause a computer to carry out the steps of:
receiving, by a firmware update module, a request to update firmware in the computing system;
receiving, by the firmware update module, a firmware update; and
initiating, by the firmware update module, a system management interrupt with the address in computer memory of the computing system at which the firmware update is stored.

14. The computer program product of claim 13 further comprising computer program instructions that, when executed, cause a computer to carry out the steps of:
storing, by a system management interrupt handler, the firmware update at a predetermined address in computer memory of the computing system; and
changing, by the system management interrupt handler, a firmware address in the computing system to point to the predetermined address in computer memory of the computing system at which the firmware update is stored.

15. The computer program product of claim 13 wherein the request to update firmware in the computing system includes the firmware update.

16. The computer program product of claim 13 wherein the firmware update includes updated run-time service code.

17. The computer program product of claim 13 further comprising computer program instructions that, when executed, cause a computer to carry out the step of designating, by the firmware update module, computer memory in the computing system at which a previous version of firmware was stored as computer memory for storing subsequent firmware updates.

18. The computer program product of claim 13 wherein the firmware update includes at least one Unified Extensible Firmware Interface (‘UEFI’) run-time service and at least one system management service.
